(19) United States
(12) Patent Application Publication
(10) Pub. No.: US 2014/0040710 A1
(43) Pub. Date: Feb. 6, 2014

(54) System for setting fees for iterative parsing, matching, and correlation of sets of text strings drawn from real time crowd-sourced streamed data and using said matches to initiate APIs or trigger alerts to participants in a crowd sourced pervasive computing environment.

(71) Applicant: Stanley Benjamin Smith, Fort Mill, SC (US)

(72) Inventor: Stanley Benjamin Smith, Fort Mill, SC (US)

(21) Appl. No.: 13/567,084

(22) Filed: Aug. 5, 2012

(51) Int. Cl. G06F 17/21

(52) U.S. Cl. 715/201

(57) ABSTRACT

A system for a user to use electronic devices to accept text input parameters to iteratively parse and process streams of data collected or converted from multiple data formats into text strings; correlating or matching said text strings against lists, tables, spreadsheets or datasets of text strings; posting and recording said text strings responsive to one or a plurality of correlations or matches with one or a plurality of items in said lists, tables, spreadsheets or datasets; posting and recording the number of parsing operations responsive to correlations or matches or user instructions upon discovery of matches or correlations of said strings of text against said one or a plurality of lists, tables, spreadsheets or datasets; and calculating a price or fee for matches or correlations discovered through said parsing process, or for other server events initiated by electronic devices responsive to said matches or correlations.

### BACKGROUND OF THE INVENTION

1. Field of the Invention

This invention relates to systems and methods for implementing a crowd sourced collection and distribution platform within a pervasive computing environment to enable data suppliers and data consumers to collect or pay fees for iteratively parsing and processing one or a plurality of streams of digital data collected from or through one or a plurality of distributed electronic devices; said data converted from digital formats such as text messages, emails, media file (audio or pixilated data), or other data formats through one or a plurality of algorithms or apparatuses or natural language parsing or processing technology into text strings; said strings being parsed for matches or correlations against sets or subsets of text strings set by the user of the system to determine or initiate one or a plurality of further actions to be executed by one or a plurality of devices capable of implementing computer readable code; and resulting in said data being profiled in real time or near real time.

2. Description of the Related Art

Natural language processing programs and other methods for conversion of streamed audio into strings of text has been available for some time. For example, voice to text software has been evolving steadily with Nuance Software and other entities building a sizable portfolio of patents and significant algorithms, codecs, and software. Media files of all types can be converted into strings of text strings and art for sophisticated codecs, algorithms, and meta-tagging processes has been evolving to enables file conversion into multiple alternate formats. Despite art and apparatuses evolving to convert streamed data into alternate formats such as text strings, there remains a need to integrate these advances into a pervasive computing environment and to fold or include outputs of said data conversion tools and technology into a data supply chain. Enabling prices, charges, and fees for operations upon data translated by or through said conversion technology and tools; particularly if said operations result in server actions and events performed by electronic devices capable of implementing computer readable code, will advance the objective of enabling intelligence analysts, emergency responders, and even ordinary computer users (consumers) to participate in and leverage a data supply chain. Note that a data supply chain, unlike the traditional model for data of retaining posting and storing said data within databases for post hoc data mining, is oriented to enable the traditional model as well as enable real time action upon data as streams of discrete datums or data items or fields or data item pairs (Smith Ser. No. 13/135,420) or tuples of data as said streams traverse the Internet from multiple electronic devices capable of implementing computer readable code in a pervasive computing environment. A meta-frame for the invention described herein is that it enables users or participants in a data supply chain to include audio and other media data into a crowd-sourced pervasive computing environment to enrich real time research capability and to enable triggering of further events and processes by electronic devices that are able to process computer readable code, operate as a server, and/or function as a temporary or permanent storage venue for data.

The invention described herein expands the capacity to implement the data supply chain and provide incentives and compensation for entities participating in data supply that has been evolving steadily since Smith introduced the term in his utility patent (U.S. Pat. No. 7,860,760). The invention described herein leverages the advantages of the data supply chain with triggered real time notifications introduced by Smith (U.S. Pat. No. 7,860,760). That invention, Smith (U.S. Pat. No. 7,860,760), enables pricing of notifications and server actions triggered by new or updated data streamed or posted into a data supply chain. Art introduced by Smith (U.S. Pat. No. 12/930,280) further enables pricing of data items for inclusion into a data supply chain through a sequence of discovery of the data item through an internet search and then calculation of its popularity or value as a search term. Smith (Ser. No. 12/932,798) also teaches art to weight and price contributions from variably weighted sources and variably weighted observations of research targets or data items. Additional art introduced by Smith (U.S. Pat. No. 12/932,797) describes a system and method for calculating fees for a participant in a data supply chain interacting with a graphical user interface (GUI) on a website or host server housing a dataset or a plurality of datasets accessible through said GUI. Further art introduced by Smith (Ser. No. 13/134,596) offers a system and method to facilitate and price data exchange through electronic devices linked to the systems and methods of Smith (U.S. Pat. No. 7,860,760, Ser. Nos. 12/932,797, and 12/932,798). Art has also been described by Smith (Ser. No. 13/200,073) to integrate fees and rewards for incremental improvements, updates, and additions of data itself into data transmission and accumulation processes within Social Networks or networks of users and servers or websites. Smith (Ser. No. 13/136,421) further introduces a system and method for pricing insertion or linking of message streams, RFID tags, UPC codes, and other data strings (such as biometric or gene sequences) to data sources. That invention, Smith (Ser. No. 13/136,421), deals with pricing the uploading of data and data streams through electronic devices, not as converted or processed files as introduced by the invention described herein. Claims of Smith (Ser. No. 13/271,157) have been examined and allowed as they introduce art to cover the enrollment of participants and pricing for participation of enrollees in a data supply chain. Art introduced by Smith (U.S. Pat. No. 13,545,891) describes a system for enabling pricing and fees for incremental improvement of research questions and research protocols or forms for participants in a data supply chain as they inform and implement real time adjustments to research processes. USPTO class 705 and art group 3625 house much of the antecedent and collateral art for the invention described herein, though other classes and groups also apply.

Raw media file data is often processed through various digital compression and shaping tools, often called “codecs,” such as MP3, WMA, RealVideo, RealAudio, DivX and XviD. There are many other more obscure codecs that also take a raw data file and turn it into a compressed file. When voice to text algorithms or image to text algorithms unwrap these codecs they convert the data into parsable strings of text that can be buffered or streamed and subjected to further processing and analysis. NLP or natural language parsing technology and tools also intersect with the system of the invention described herein insofar as the technology and tools convert data into text strings.

Prior art anticipating or pointing toward the system of the invention described herein is introduced by Fairweather (U.S. Pat. No. 7,685,083) which will be cited at length to illustrate the common approach taken to the problem of data matching and correlation of much prior art. Fairweather's abstract for his invention (U.S. Pat. No. 7,685,083) states that his invention is for “An intelligence system . . . that is comprised of several basic components: a system for converting incoming unstructured data into a well described normalized form supported by a dedicated ‘mining’ language tied intimately to a system ontology; a system for accessing and manipulating data held in memory or in persistent storage in its normalized binary form; an ‘ontology’ that represents and contains the items and fields necessary for the target system to perform its function; a memory system tied to the ontology; a memory management system for splitting incoming data into those portions to be directed to each container; a query system for querying each container to retrieve portions of composite objects; a UI to display and interact with data within the system; a memory system that forms collections of datums and enables manipulation and exchange of these collections both within the local machine as well as across the network.”

The reader of Fairweather's abstract for his invention can readily sense the complexity of the system. Prior art assumes a need for persistent data containers, such as databases, which then obviate issues of query structure and design that are bypassed by simple parsing of a stream of text strings for a match or correlation. Prior art also assumes data object configurations such as tuples, rather than strings of text. Both of these distinctions between the art of the invention described herein are illustrated by the first claim of Fairweather's invention. “1. A method for facilitating meta-analysis of data captured for intelligence purposes using a computer network and implemented as an unconstrained system, the method comprising the steps of: (a) establishing a distributed acquisition server architecture within the computer network responsive to a data-flow driven environment; (b) sampling a plurality of streams of unstructured data by said distributed acquisition server architecture; (c) converting said plurality of streams of unstructured data into a well described normalized form of binary data via a dedicated mining language tied to a current system ontology; (d) storing said converted binary data in a memory system tied to said current system ontology within said computer network, wherein said memory system defines a plurality of persistent storage containers required to contain said converted binary data; (e) directing said storing step with a memory management system which splits said converted binary data into an appropriate one of said plurality of persistent storage containers; (f) executing one or more control and/or data-flow based programs, called widgets, on said converted binary data stored in said plurality of persistent storage containers, wherein execution of said one or more widgets begins when a matching set of data objects or tokens from said converted binary data appear on an input data-flow pin of said one or more widgets; (g) producing a set of resultant data tokens on an output data-flow pin of said one or more widgets, wherein said set of resultant data tokens become part of said data-flow driven environment in said persistent storage containers or in a memory of a computer within the computer network; (h) querying a registered search capability of one or more said plurality of persistent storage containers producing a list of hits; (i) querying said list of hits with Boolean and other operators to specify logical combinations of said list of hits; (j) displaying and interacting with said plurality of streams of unstructured data, said list of hits, and said logical combinations of said list of hits through a user interface on a display device within the computer network; (k) forming collections of datums from said logical combinations of said list of hits through a memory collections system that forms and enables manipulation and exchange of said collections of datums both within a local computer as well as across the computer network; (l) delivering said collections of datums for meta-analysis to a user accessing the computer network through said user interface; and (m) based upon said meta-analysis by said user, revising said querying steps (h) and (i) repeating steps (j), (k) and (l).”

Potential overlap of Fairweather's claim with the invention described herein begin with (h) through (k) in his Claim 1, but (h) assumes a “persistent storage container” not real time processing of a stream of data, and (j) assumes display of the queried data for further analysis that shifts the art described by Fairweather into visualization and reporting and other processes that are obviated by the invention described herein. Fairweather offers no art for calculating costs and fees as is integral to the system of the invention described herein; and rather than feeding “a system for meta-analysis”, the invention described herein introduces art for a system that can act upon data as a string of text in real time, bypassing much of the ontology required and explicated through Fairweather's claims. When data is managed separately from a database, indeed when data is viewed and processed simply as a series of strings of text that may be optionally stored for later processing or managed in real time, methods for managing said data are simplified.

The invention described herein addresses a system and method for implementation of a subset of a data supply chain we have labeled C3 in the group of four fundamental components of a data supply chain we label as “Delta4C:”

C1=Connect and enroll all involved parties or participants rapidly and effectively from a distributed network to properly include and assign observers or data contributors into a process for data contribution

C2=Collect real time observations from a full circle of contributors with variable weighting for reputation and access to relevant information

C3=Compute the values and ratings of accumulated observations to assess whether thresholds for risks or alerts have been met or surpassed

C4=Communicate or notify the right parties regarding information that is actionable for them

The method and system of the invention described herein focuses upon the term labeled “C3” in the list and enables collection, parsing, processing, and exchanges of fees or other consideration for one or a plurality of matches or correlations of data items derived from streamed text strings against comparative sets and subsets of text strings set by a user of the system of the invention described herein.

Other prior art where claims intersect claims of the invention described herein is represented by Gupte's invention (U.S. Pat. No. 8,219,493) titled “Messaging method and apparatus for use in digital distribution systems” In Gupte's abstract he offers a “method of subsidizing the presentation of media content by including informative messages as part of the presentation. The presentation of the media content is paused while the informative message is presented. The cost of the media content is credited to the owner and the payment associated with the informative message is debited from the sponsor of the informative message. Some content is segmented into sections and the informative messages are presented before or after each section.” While there is no overlap of claims, the association of streamed media content with a pricing schema for associated data is a rare example of a correlation of a pricing approach that can be implemented through a data supply chain. Another potentially relevant example of prior art is Boncyk, et al. (U.S. Pat. No. 8,218,874) whose invention for “Object information derived from object images” addresses a “transaction” system for search terms to be “derived automatically from images captured by a camera equipped cell phone, PDA, or other image capturing device, submitted to a search engine to obtain information of interest, and at least a portion of the resulting information . . . transmitted back locally to, or nearby, the device that captured the image.” While there is no art that overlaps the claims of the invention described herein, there is art for the “transaction system comprising: a mobile device configured to acquire data including biometric data and relating to an object; an object identification platform configured to obtain the acquired data, recognize the object as a target object based on the acquired data, and determine object information associated with the target object; and a content platform configured to obtain the object information, and initiate a transaction associated with the target object with a selected account over a network based on the object information and the biometric data.” The intersection of Boncyk's art and the invention described herein is broken at the point that the data is connected to an object, but the art to determine the potential for a transactional relationship and a data stream do parallel the intent of the system and method of the invention described herein.

Srinivasan, et al. (U.S. Pat. No. 8,204,875), in his invention, “Support for user defined aggregations in a data stream management system,” offers art for “a computer . . . programmed to accept a command to create a new aggregation defined by a user during execution of continuous queries on streams of data. The computer is further programmed to thereafter accept and process new continuous queries using the new aggregation, in a manner similar to built-in aggregations. The user typically writes a set of instructions to perform the new aggregation, and identifies in the command, a location of the set of instructions. In response to such a command, the computer creates metadata identifying the new aggregation. The metadata is used to instantiate one aggregation for each group of data in a current window, grouped by an attribute identified in a new query.” Srinivasan diverges from the art of the invention described herein when he evolves his method to generate aggregations and append meta data. The overlay of iterative aggregations in Srinivasan's claim 1 and the constraint of the system to deal with data as tuples that are characterized and stored and counted and re-aggregated for further processing diverges from the simple counting and pricing of matches and correlations of the invention described herein. However Srinivasen's art could well supplement system of the invention described herein. In fact, a combination of the art introduced herein with art introduced by Fairweather and art introduced by Srinivasan would provide a rich foundation for data parsing for homeland security staff and for emergency responders dealing with real time streamed data.

Aravamudan, et al. (U.S. Pat. No. 8,122,034) introduces art for a “method and system for incremental search with reduced text entry where the relevance of results is a dynamically computed function of user input search string character count.” He describes a “search request . . . directed at identifying a desired item from a set of items. Each of the items of the set of items has one or more associated terms . . . each character of the query input . . . having one or more terms matching the characters . . . dynamically identified. The items in this group of items are ordered based on relevance values of the terms matching the characters and on the number of characters of the query input used in identifying the group of items. Identification of the group of items as ordered is transmitted to the user to be displayed on a device operated by the user.” The purpose or use of the discovered matches in the method described by of Aravamudan is quite different, but the dynamic identification of common characters is similar to a portion of the process of the invention described herein. Downs, et al. (U.S. Pat. No. 8,190,541) also offers art for matching, in his case, matching “domains of interest” using techniques that “include automatically analyzing documents, terms and other information related to a domain of interest in order to automatically determine information about relevant themes within the domain and/or about which documents have contents that are relevant to such themes.” His search and query methods parallel those of Aravamudan, but his art is directed to “assist users in specifying themes of interest and/or in obtaining documents and/or document fragments with contents that are relevant to specified themes.” McCall, et al. (U.S. Pat. No. 7,058,710) introduce art to collect, analyze, consolidate, deliver, and utilize data relating to a current event from a plurality of sources while maintaining the data for use as a “proactive emergency management and disaster response information system that can also be used for emergent commercial purposes. A data capture device associated with an individual or a location captures data related to a current event or affected site. Incoming data may include raw data, repackaged data, or value-added data from source inputs. Captured data is sent to a centralized command center or distributed command centers where it is analyzed, resolved, correlated and repackaged for use by other parties.” McCall offers art aimed at leveraging real time data for emergency response, but that is the extent of the overlap with the invention described herein

Yatviskiy, (20030009443 describes “a method, device and system for increasing the speed of processing data. The inventive method includes filtering the data, classifying the data, and generically applying logical functions to the data without data-specific instructions. Moreover, the steps of filtering, classifying and applying logical functions are based on predetermined criteria. The inventive method further includes storing the data in an in-memory database.” While the intent of Yatviskiy is to increase processing speed, his method also breaks data into strings of streamed text, but he does not introduce art for pricing said stream or matching or correlating said streams. The introduction of logical functions by Yatviskiy takes the focus and application of his invention into building of databases and away from real time streamed data as is introduced through the art of the invention described herein.

Matsakis; et al. (20050273772) introduces art for a “Method and apparatus of streaming data transformation using code generator and translator” that converts data formats through “a flexible transformation mechanism” that “facilitates generation of translation machine code. A translator is dynamically generated by a translator compiler engine. When fed an input stream, the translator generates an output stream by executing the native object code generated on the fly by the translator compiler engine. In addition, the translator may be configured to perform a bi-directional translation between the two streams as well as translation between two distinct protocol sequences. Further a translator may work in streaming mode, to facilitate streaming processing of documents”. Matsakis art has a similar intention to the art of Yatviskiy. Both approach the issue of managing and categorizing and sorting data prior to storage in a database. Another invention that addresses the same issue in a very different manner is McGaffey, et al. (U.S. Pat. No. 6,556,982), who introduces art for a “data analysis and classification system that reads the electronic information, analyzes the electronic information according to a user-defined set of logical rules, and returns a classification result. The data analysis and classification system may accept any form of computer-readable electronic information. The system creates a hash table wherein each entry of the hash table contains a concept corresponding to a word or phrase which the system has previously encountered. The system creates an object model based on the user-defined logical associations, used for reviewing each concept contained in the electronic information in order to determine whether the electronic information is classified. The data analysis and classification system extracts each concept in turn from the electronic information, locates it in the hash table, and propagates it through the object model. In the event that the system cannot find the electronic information token in the hash table, that token is added to a missing terms list. If any rule is satisfied during propagation of the concept through the object model, the electronic information is classified.” The art of the invention described herein shares a similar interest in classification, but the system is much more direct and straightforward.

Pollack, et al (U.S. Pat. No. 7,974,975) in “Method and apparatus for distributing information to users” describes art for “providing information to a plurality of users based on the relevancy of the information to the users. In Pollack's art “an incoming message is received. Similarity scores are generated indicating similarities of the incoming message to features of a plurality of messages. Relevancy scores are generated for the plurality of users, the relevancy scores indicating relevancies of the incoming message to the plurality of users based on the similarity scores and a plurality of user profiles including information descriptive of the plurality of users' preferences for the features of the plurality of users. Message information derived from the incoming message, the relevancy scores, and the plurality of user profiles is delivered to at least some of the plurality of users.” There is no pricing schema or consideration of streaming of media files as in the invention described herein, and the intervening focus on “relevancy” constrains the use and implications of the method, but the intent of discovering and tagging content is shared by the invention described herein.

Cialowicz; et al. (20110251977) describes art for “ad hoc document parsing” that also shares the intent of discovering and tagging relevant content across documents. Cialowicz's claims are directed to documents and not streams of text strings. However, the interest of Cialowicz in natural language processing correlates with the interest of the invention described herein.

The thrust of much of the prior art has been on formal and complex operations upon abstracted data to classify said data and shape it for posting into a data structure. The intent of the art of the invention described herein is to enable the non-technical user to exercise judgment and choice in a similar manner to a non-technical user putting together a set of search terms. The list of terms may be long and the iterations may be many, but the complexity of the user's activity is minimal. Instead of complex ontological schemata, the invention focuses on simple matches and correlations of text strings that are outputs of a natural language processing algorithm or a media codec or a conversion of a data object to a text string by a data parsing engine. The operation of the engine or system used to convert a data stream into text strings is not the province of the invention described herein. Neither is it the province of the invention described herein to consider systems or methods for data visualization and analysis beyond the simple tabular presentation of matches and correlations of text strings in a data stream against the set or sets of comparison strings of text available on the one or a plurality of electronic devices participating in the crowd sourced pervasive computing environment of a data supply chain.

### BRIEF SUMMARY OF THE INVENTION

The invention enables a user to set fees for iterative parsing, matching, and correlation of sets of text strings drawn from real time crowd-sourced streamed data and using matches to initiate APIs or trigger alerts to participants in a crowd sourced pervasive computing environment.

The invention enables a user to use an electronic device capable of processing computer readable code to accept text input parameters to iteratively parse and process one or a plurality of real time or near real time streams of data collected from or through one or a plurality of distributed electronic devices included in a pervasive computing environment, said data converted from audio or other data formats into text strings; correlating or matching said text strings against lists, tables, spreadsheets or datasets of text strings housed upon the one or a plurality of electronic devices capable of implementing computer readable code; posting and recording said strings or subsets of text strings responsive to one or a plurality of correlations or matches with one or a plurality of items in said lists, tables, spreadsheets or datasets; posting and recording the number of iterations of parsing operations responsive to correlations or matches or user instructions upon discovery of matches or correlations of said strings of text against said one or a plurality of lists, tables, spreadsheets or datasets; and calculating a price or fee for the number of matches or correlations discovered through said parsing process, or for the number of iterations of matching or correlating operations or initiations of API' s or other server events initiated by said electronic device responsive to said matches or correlations.

The invention enables one or more users to use an electronic device capable of processing computer readable code to accept input of strings of text to match or correlate or compare against streams of text obtained from files converted to strings of text from variable file formats. It enables an interface for a user to accept and post sets or subsets of grouped text strings to tables, spreadsheets, documents, or data structures. These sets or subsets of text are discovered by parsing streams of text transmitted from one or more distributed electronic devices and matched or correlated or compared through computer readable code against the text in the lists, tables, spreadsheets, documents, data structures, hyperlinks, or reference notes on the electronic device hosting the lists, tables, spreadsheets, documents, data structures, hyperlinks, or reference notes. The process of parsing, matching, extracting, and posting is repeated according to instructions of the user of an electronic device capable of executing computer readable code to identify matched sets of text and, responsive to identifying a match posting the matched sets and subsets of text to one or a plurality of lists, tables, spreadsheets, documents, data structures, hyperlinks, or reference notes accessible to the user of the system. The relationships of the sets and subsets are calculated, configured, ordered, and counted according to criteria set by the user of the system; and the number of iterations of parsing matching and posting implemented in response to the one or a plurality of matches discovered by the system of the invention is also counted. These are associated with a fee or charge for accepting and posting one or a plurality of lists, tables, spreadsheets, documents, data structures, hyperlinks, or reference notes; a fee or charge for the number of iterations of parsing matching and posting implemented in response to one or a plurality of matches discovered by the system of the invention; and a fee or charge for the number of matches returned by the system of the invention responsive to criteria set by the user of the system.

A user or administrators of the invention may designate files transmitted from the one or a plurality of electronic devices capable of processing computer readable code to be parsed for meta tags or attributes; such as file sources, owners, originators, generation devices, creation dates, modification dates, original file formats, or combinations of meta tags. A user may instruct a device capable of implementing computer readable code to cache or to post and associate matched or correlated text discovered through the invention with meta tags or file attributes into lists, tables, spreadsheets, documents, data structures, hyperlinks, or reference notes.

A user or administrator of the invention may also instruct the device capable of implementing computer readable code to implement one or a plurality of parsing parameters for the one or a plurality of streams of text by number of characters or subsets of characters preceding or following a match or correlation with sets of subsets of text with one or a plurality of lists, tables, spreadsheets, documents, data structures, hyperlinks, or reference notes or by one or a plurality of attributes or meta tags associated cached or posted upon the device capable of implementing computer readable code.

A user or administrator of the invention may designate the number of characters and contextual parameters preceding or following a match or correlation as a parsing parameters for the one or a plurality of streams of text. A user or administrator of the invention may instruct the device capable of implementing computer readable code to use a time or date stamp as an additional parsing parameter prior to determining a match or correlation with sets or subsets of text in the lists, tables, spreadsheets, documents, data structures, hyperlinks, or reference notes. The device capable of implementing computer readable code may accept spoken input from the user of the device to convert spoken input into a text string to be used to determine a match or correlation with the one or a plurality of sets or subsets of text.

The user or administrator of the invention is enabled by the invention to link or associate an API (application programming interface) responsive to said matches or correlations with sets or subsets of strings of text housed in one or a plurality of lists, tables, spreadsheets, documents, data structures, hyperlinks, or reference notes such that the API is initiated responsive to said matches or correlations. The API accepts and posts a record of matched or correlated strings to one or a plurality of data storage tables or to a persistent data cache within the memory of an electronic devices that initiates the execution of the API.

The invention described herein can induce and increase participation in data supply by assigning rewards and incentives, (note that incentives, as described in the prior art discussion include prices and fees) to members of the “crowd” as they participate in said data supply chain. Tallying the iterations of server actions upon discovery of matches and correlations across and among text strings advances a market (note that a “market” includes buyers and sellers and at least one process for facilitating an exchange) and trading platform for data exchange. Further, the discovery of matches and correlations enables the user or device participating in the system of the invention described herein to initiate one or a plurality of API's or trigger one or a plurality of server actions responsive to said matches or correlations. In this manner a pervasive computing environment enables the non-technical user to perform data profiling functions and activities and derive value from streamed or stored data included into a data supply chain. Enabling real time discovery and response to matches of streamed data with terms or sets of text strings of interest to a participant in a data supply chain will particularly advance the interests of those who wish to proactively manage risk.

### BRIEF DESCRIPTION OF THE DRAWING

FIG. 1. “Processes, Actions” is a diagram of components and linked operations.

### DETAILED DESCRIPTION OF THE INVENTION

Boncyk, et al. (U.S. Pat. No. 7,680,324), who is also cited above for his art in Boncyk, et al. (U.S. Pat. No. 8,218,874) introduces art to use “image-derived information as search criteria for internet and other search engines.” Boncyk pulls or obtains search terms (which are strings of text) “automatically from images captured by a camera equipped cell phone, PDA, or other image capturing device, submitted to a search engine to obtain information of interest, and at least a portion of the resulting information . . . transmitted back locally to, or nearby, the device that captured the image.” The routing and storing of the search strings has little in common with the invention described herein, but is instructive for setting context for the invention described herein. Boncyk is quoted at length because his description of standard search technology is apt and helpful.

“In the 1990s Yahoo!™ introduced the idea of indexing web pages accessible on Internet, and providing a Search Engine to access the index. Since that time dozens of other searching systems have been developed, which use all manner of various search methods, algorithms, hardware and/or software. All such systems and methods that accept user inputs of Key Information, and then utilize such Key Information to provide the user with information of interest, are referred to herein as Search Engines. The user, of course, can be a natural person, as well as a device (computing or otherwise), algorithm, system, organization, or any other entity. In searching for information, a Search Engine can utilize any suitable search domain, including for example: A database (including for example a relational database, an object database, or an XML database). A network of resources including for example web pages accessible within the Internet; and A public or private collection of documents or information (e.g., documents, information, and/or messages of a company or other organization(s)) such as that maintained by LEXIS.™.

In a typical search, Key Information is provided to the Search Engine in the form of key words comprising text, numbers, strings, or other machine-readable information types. The Search Engine then searches its indices of web pages for matches, and returns to the user a hyperlinked listing of Internet Uniform Resource Locators (“URLs”) as well as some brief display of context in which the key word(s) are used. The information of interest can sometimes be found in the hyperlinking listing, but is more frequently found by linking directly to the listed web pages.

Providing Key Information to Search Engines in the form of text strings has inherent difficulties. It involves strategy in the selection of the text to be entered, and even with respect to the format of the keywords (for example using wildcards). Another difficulty is that small computing and/or telephony devices (e.g. telephones, both mobile and non-mobile), have small and/or limited keyboards, thus making text entry difficult.”

The system of the invention described herein operates within the constraints and limitations of text strings described by Boncyk, but the simple iterative process of parsing a real time data stream or near real time data stream derived from audio or video or other file types, including web pages, in order to recognize and match an text string against one or a plurality of alternative lists of user determined text strings is an advantage in the context of pervasive computing where one or a plurality of devices can perform multiple operations and parallel processes, and where memory and caching can be distributed across said devices to manage and transcend said constraints.

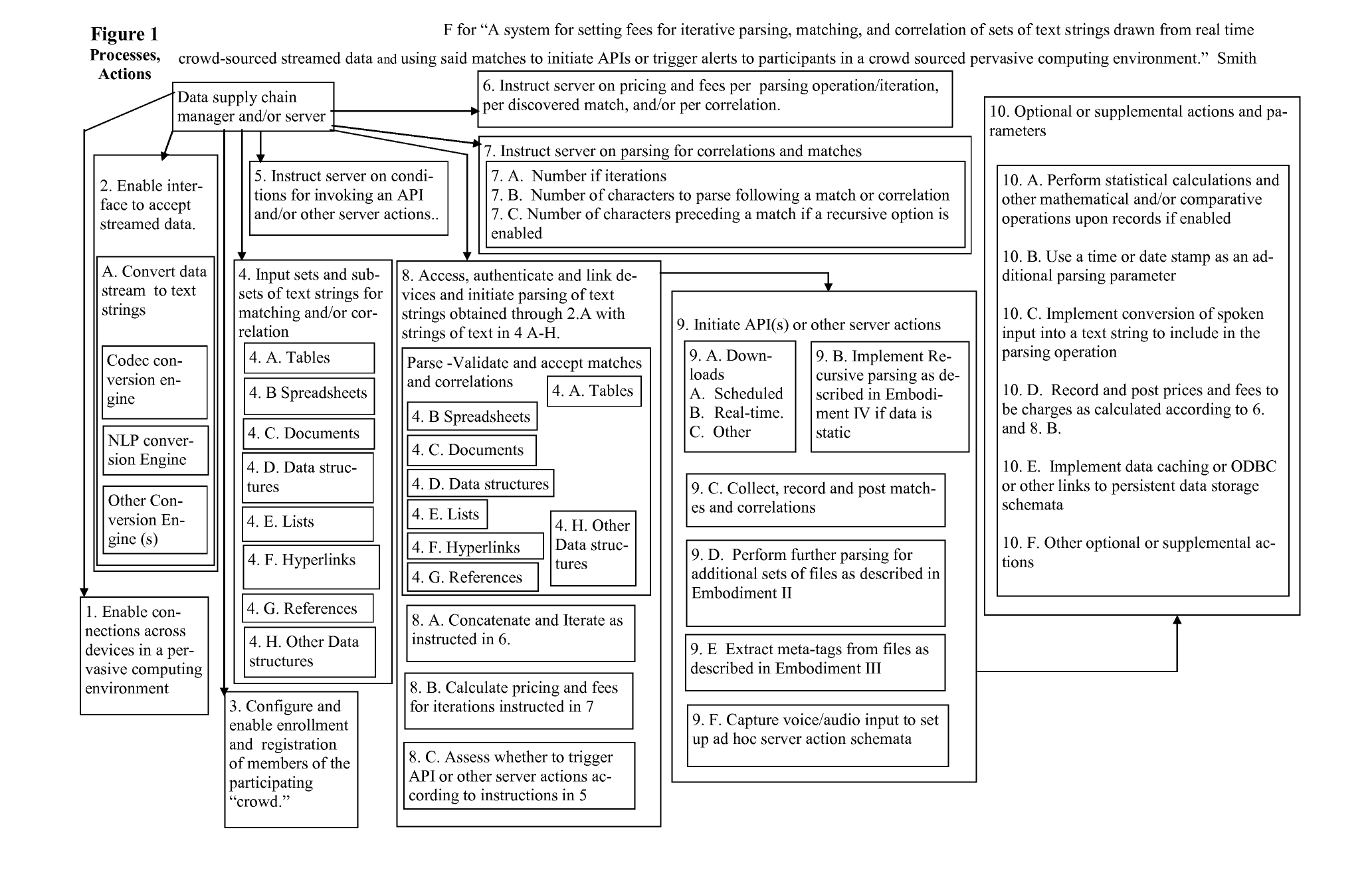

The simplicity of the invention described herein lends itself to direct description of embodiments and a simple illustration in FIG. 1. Embodiments described are intended to be examples of implementation of the system of the invention herein, but are not intended to constrain alternative configurations and embodiments aligned with the claims of said invention. Any embodiment may enable counts of operations performed by an electronic device capable of implementing computer readable code and functioning as a server to implement the system of the invention described herein in order to determine a price or value or fee for said operations. It is expected that embodiment will enable or include other operations, such as statistical or mathematical analysis and discovery of relationships among matched or correlated strings of text, said strings housed in tables for comparison or correlation with user selected or entered strings of text.

### Embodiment I

Streams of TV program audio converted into text strings—for example CNBC live broadcasts—are parsed to discover one or a plurality of sets of text letters or labels or terms that have been placed by a user through a user interface on an electronic device into tables, spreadsheets, documents, or data structures linked to one or a plurality of electronic devices such as a smart phone or tablet computer. An example of said one or a plurality of sets of text strings could be the set “BA and C” among a table of letters, labels or terms for stock symbols and names of companies i.e. “Bank of America.” Responsive to user input or to computer readable code, the system then counts and stores the number of matches or correlations of terms in one or a plurality of associated tables, spreadsheets, documents, or data structures such as “buy” versus “sell” or “good” versus “bad” or “strong” versus “weak” or “up” versus “down” for as many terms as are enabled through the instructions entered through the user interface upon one or a plurality of devices capable of or configured to be capable of implementing computer readable code. Responsive to validating or accepting said initial match through computer readable code on the device or through user interaction with said device, the system initiates further forward chains of actions responsive to computer readable code; such as seeking further correlations or matches with other sets or subsets of text strings in the data stream following the discovery of a match by iteratively testing for said matches or correlations in one or a plurality of additional tables or spreadsheets or documents or data structures on one or a plurality of electronic devices that are part of a pervasive computing environment. The system instructs the one or a plurality of electronic devices participating in the data supply chain capable of implementing computer readable code to authenticate the data stream by device or by user authentication schema and retain and cache or store a count and/or post to a table the number of matches discovered; and also to post and store a record of the matched strings or the matched strings themselves. The user of the system or an electronic device capable of executing computer readable code may system may assign a value or price for the type or category of matches and correlations. Upon reaching a trigger threshold set by the user (their “risk or tag level”) and a time window (could be milliseconds up to years), a connection to a device enabled to implement the system of Smith (U.S. Pat. No. 7,860,760) is initiated in order to trigger a notification where the acknowledgement of the notification initiates a connection to the stockbroker and that connection enables the user to select his volume of shares and the price he would like to offer and the time frame for the offer. This is real time action upon news. The intent of this embodiment and of the other exemplary embodiments is to enable real time or near real time reposes to identification of sets and subsets of text that match one or a plurality of lists, tables, spreadsheets, documents, data structures, hyperlinks, or reference notes accessible to the user of the system. The real-time (or near real time) data profiling advantages of the system enable more than simple copying and posting, but can enable linking that ranges from a web hyperlink to a set of information to jog a person's memory such as reference notes.

### Embodiment II

An agency obtains a warrant or court order for a search of computer files or audio files or emails or other data convertible to text strings. An authorized representative of said agency initiates a parsing procedure of emails and audio and/or other files that might match terms or text strings authorized by said court order for the agency. An example might be the name of a suspected terrorist or an email address of a suspected criminal accomplice. Upon discovery of a match, the agency initiates a parsing procedure of associated or linked datasets or records that match terms in the agency's authorized text character set lists. If these are matched, the dates and times of the emails are extracted and posted to be compared against the agency's authorized date range set by said court order. If these date ranges correlate, the entire data stream associated with the tagged and matched dataset or records is pulled into a file and stored or transmitted to the authorized representative.

The advantage for constitutional protection against unreasonable search and seizure and respect for individual privacy for this embodiment is that agency representatives need not conduct random searches or view data that is not specifically authorized through court orders based upon probable cause and specification of text strings in search warrants. Upon reaching a count value (trigger threshold) set by the court or by the user, a connection to a device enabled to implement the system of Smith (U.S. Pat. No. 7,860,760) is initiated to notify agency representatives of a need for further action.

### Embodiment III

A homeland security or other risk management entity builds a list of terms for features and aspects of an emergency event, such as a flood, and obtains permission from the appropriate authority to parse Twitter streams or SMS message streams convertible to strings of text from a geographic catchment area to match against said list of terms relevant to said emergency. Upon discovery of a specified quantity of said strings, the agency parses the messages for additional text strings to be matched against or correlated to build a scope and process map of the distribution and severity and features of said emergency in order to determine emergency response methods, systems, events, and actions. Also, said agency may parse said strings for location information, the originator of the message stream, and for other features that might help to locate and identify persons most at risk due to said emergency. Upon reaching a count value (trigger threshold) set by said entity, a connection to a device enabled to implement the system of Smith (U.S. Pat. No. 7,860,760) is initiated to notify other participants in the data supply chain.

### Embodiment IV

A consumer sets up a list of correlations or matches and the strings for the initial set or sets of text to be used by the parsing process of the invention described herein upon landing on one or a plurality of web pages or upon accessing one or a plurality of databases, one or a plurality of documents, or one or a plurality audio or video files. Since the streams of text in this embodiment tend to be consistent and static, rather than streamed through live real time methods and processes, the parsing process may include recursive parsing of a number of text strings preceding discovery of a match with one or a plurality of sets of text strings in the one or a plurality of sets of text strings. An extension within this embodiment may apply searches for specific bits of data such as a signature of a virus on a stream of bits or a signature associated with a document indicating a security status.

### Embodiment V

Responsive to a correlation or match set up according to the method of Embodiment IV of the invention described herein, computer readable code instructs one or a plurality of devices acting as a server to invoke one or a plurality of API's (application programming interfaces), each application able to invoke forward or backward chaining of server actions including invoking other API's associated with said embodiment. Thus the system of the invention described herein is enabled to leverage a pervasive computing environment to initiate actions across devices associated with the system of the invention described herein responsive to discovery of matches or correlations. Further, this embodiment counts and stores the count of the chain of one or a plurality of API's initiated for said one or a plurality of instances of initiation of an API. A variant of this embodiment is the use of an electronic device to capture a real time stream of audio input or spoken input by said device spoken by a participant in a data supply chain; to subject the spoken input to conversion through a natural language processor into text strings; and then to apply the matching and correlation process to said text strings. This enables a user to set up an ad hoc server action schema that triggers one or a plurality of API's or a sequence of one or a plurality of API's upon matches or correlations that are pre-set by the participant in the data supply chain.

A Detailed Explication of FIG. 1 Labeled Processes and Actions and Offered as an Amendment to the Specification Follows:

FIG. 1 is intended to illustrate the operation of a sample embodiment of the invention. Since the invention furthers art for the data supply chain, the first numbered tag labeled “1” illustrates that the data supply chain will enable connections across devices in a pervasive computing environment. “2” illustrates how the connections across devices provide users or administrators at least one interface to instruct at least one device to accept streamed data. The grouping under “2” with a label of “A” addresses the conversion of a data stream into text strings required for the proper operation of the invention. Exemplars of the kinds of conversions as described in remainder of the specification are conversion of Codecs, conversion of data streams by a natural language processor (NLP), and perhaps other conversions of data streams by other data transformation engines. The tag labeled “3” addresses the portion of the system to configure and enable enrollment and registration of members of the participating “crowd.” The tag labeled “4” points to the examples of sets and subsets of text strings for matching and/or correlation. Examples of such text strings are those listed as 4 “a” through “h” and include formats that commonly can be extracted as text strings, though the invention can be applied to pull text strings out of uncommon formats as well. The tag labeled “5” points to the step following designation of formats for extraction of text strings to further instruct a server on conditions established by the user or administrator for invoking an API or other server actions. The tag labeled “6” points to how a user or administrator can instruct a server regarding pricing and fees as one or more parsing operations or parsing iterations yields or discovers a match or a correlation of text strings entered by the user or administrator and against the data streams being parsed for matches or correlations. “7” indicates how the user or administrator may instruct a server to parse for correlations and matches based on “7. A.” the number if iterations, or “7. B.” the number of characters to parse following discovery of a match or correlation, and “7. C.” the number of characters preceding a match if a recursive option is enabled by the administrator or user in the embodiment.

Through the tag labeled “8”, FIG. 1 points to the accessing, authenticating and linking to other electronic devices to initiate parsing of text strings obtained as in “2.A” with strings of text in “4. A.” tables, “4. B”, spreadsheets, “4. C.” documents, “4. D.” data structures, “4. E.” lists, “4. F.”, hyperlinks, “4. G.” references, or “4. H.”, other data structures. Further, through the tag labeled “8”, FIG. 1 illustrates that operations for “8. A.” for concatenating and iterating will then “8. B.” calculate pricing and fees for iterations as instructed according to “7”. Finally, as in “8.C.”, determine whether conditions have been met to trigger an API or other server action.

In the tag labeled “9.”, qualifiers for initiated API(s) or other server actions, such as “9.A” downloads that are “A” scheduled or “B.” real time or “C.” other downloads. If the data is static data as in Embodiment IV, the administrator or user may implement recursive parsing, 9B”. In most, if not all instances, collecting, recording and posting matches and correlations s in “9. C.” is expected. There may be instances when further parsing for additional sets of files as described in Embodiment II are advantageous as in “9. D.” or where extraction of meta-tags from files as described in Embodiment III “9. E.” would be implemented by the user or administrator. Even the capture of voice/audio input from a user or administrator to set up ad hoc server actions or other schemata “9. F.” is part of how the system will operate.

This specification for implementation of API's or other server actions will further include optional or supplemental actions and parameters set up by the administrator or user as in “10.” such as the performance of statistical calculations and other mathematicaland/or comparative operations upon records if enabled “10. A.”; the use of a time or date stamp as an additional parsing parameter “10. B.”; the implementation or conversion of spoken input into a text string to be included into the parsing operation “10. C.”; and recording and posting prices and fees to be charged as calculated according to “6.” and “8. B.” of FIG. 1 and as pointed to by “10. D.”. Even implementation of data caching or ODBC or other links to persistent data storage schemata can be enabled by a user or administrator as in “10. E” along with other optional or supplemental actions pointed to by “10. F.”

1. A method for one or a plurality of users to set criteria for directing an electronic device configured to process computer readable code to accept input of strings of text to match against streams of text obtained from one or a plurality of files converted to strings of text from one or a plurality of file formats being transmitted by one or a plurality of electronic devices;
responsive to said matching, posting into memory upon said electronic device said strings of text;
responsive to said posting, calculating ordering and counting of matches of said sets and subsets of text;
responsive to said calculating ordering and counting of matches of said sets and subsets of text, implementing a price or fee for the number of said matches; and
responsive to said implementing a price or fee for the number of said matches, processing financial transactions to collect said price or fee for the number of matches returned by the method of the invention responsive to criteria set by the one or a plurality of users of said method.

2. The method of claim 1, wherein one or a plurality of users of said method may, upon discovery of said matches of matches of said sets and subsets of text, designates one or a plurality of files containing said matches to examine for one or a plurality of attributes to identify file sources, owners, originators, generation devices, creation dates, modification dates, and original file formats; and
wherein the user of said method may instruct a device configured to process computer readable code to associate with said one or a plurality of sets of matched or correlated text strings discovered through the method of claim 1 with said one or a plurality of file attributes resulting from said examination for use in assigning fees or charges and for use in implementing financial transactions to collect said fees or charges for said one or a plurality of sets of matched or correlated text strings discovered through the method of claim 1.

3. The method of claim 1, wherein one or a plurality of users of said method may instruct said device configured to process computer readable code to implement one or a plurality of parsing parameters for the one or a plurality of streamed strings of text by number of characters or subsets of characters preceding or following discovery of a match of said strings of text from one or a plurality of file formats being transmitted by one or a plurality of electronic devices;
posting said number of characters or subsets of characters preceding or following discovery of a match resulting from said parsing into memory upon said electronic device; and
responsive to said posting, calculating ordering and counting of said characters.

4. The method of claim 1, wherein one or a plurality of users of the method may designate the number of characters and contextual parameters preceding or following a match as a parsing parameter for the one or a plurality of streams of text.

5. The method of claim 1, wherein one or a plurality of users of the method may instruct said device configured to process computer readable code to instruct said device to accept spoken input; and
wherein said device configured to process computer readable code is enabled to convert said spoken input into a text string to use to parse for a match with said one or a plurality of text strings within a stream of text.

6. The method of claim 1, wherein one or a plurality of users of the method links or associates prices or fees with one or a plurality of API's (application programming interfaces) triggered responsive to matches of strings of text; and
initiates further forward chains of actions responsive to computer readable code.
